(19) United States
(12) Patent Application Publication
(10) Pub. No.: US 2013/0092037 A1
(43) Pub. Date: Apr. 18, 2013

(54) STAMP SYSTEM WITH STAMPING JIG

(71) Applicant: Dimension Crafts LLC, Wyomissing, PA (US)

(72) Inventors: Mark SHAINWALD, Hoboken, NJ (US); Matt SWEENEY, Bloomfield, NJ (US); Sueann CAPELA, Bogota, NJ (US); Todd TRAINER, Shillington, PA (US); Cara FARLEY, Blairstown, NJ (US); Brian SHELLABEAR, Reading, PA (US)

(73) Assignee: DIMENSION CRAFTS LLC, Wyomissing, PA (US)

(21) Appl. No.: 13/653,120

(22) Filed: Oct. 16, 2012

Related U.S. Application Data
(60) Provisional application No. 61/640,811, filed on May 1, 2012.
(60) Provisional application No. 61/548,108, filed on Oct. 17, 2011.

(51) Int. Cl. B41J 27/04

(52) U.S. Cl. 101/103

(57) ABSTRACT

A stamping system includes a jig having a plurality of first alignment features spaced about the jig, and a stamping block including at least one second alignment feature. The second alignment feature is selectively engageable with individual ones of the plurality of first alignment features and is provided to align the stamping block with respect to the jig such that a uniform pattern of stamps can be formed on a work surface by moving the stamping block from one first alignment feature to another.

### CROSS-REFERENCE TO RELATED APPLICATIONS

This application claims the benefit of and priority to U.S. Provisional Patent Application No. 61/640,811, filed May 1, 2012, and U.S. Provisional Patent Application No. 61/548,108, filed Oct. 17, 2011. The entire contents of each of the foregoing applications are hereby incorporated by reference herein.

### TECHNICAL FIELD

The technical field relates to stamps and stamping systems for use in applying ink stamps to work surfaces, such as in craft projects.

### BACKGROUND

Ink stamps are known for applying patterns, letters, numbers, and other indicia to a work surface. Ink stamps are used in a variety of applications, including, for example, in office settings for applying mailing addresses, labels, dates, and other frequently required pieces of information to mailings, letters and other paperwork. Ink stamps are also used to apply decorative patterns to a work surface such as paper or card stock for use in scrapbooks, custom-made stationary, and the like. Stamps may also be applied to walls, furniture, or substantially any other surface where it is desired to apply a decorative or informative pattern or other indicia. Creating certain decorative indicia can involve the repetitive application of one or more stamps in a repeating pattern.

### SUMMARY

The subject matter addressed herein relates generally to stamps and stamping systems for use in applying ink stamps to work surfaces such as in craft projects. Features, advantages and embodiments of the subject matter may be set forth, or be made apparent, from consideration of this disclosure. It is to be understood that this disclosure is exemplary in nature and sets forth certain aspects of the relevant subject matter without limiting the scope of the appended claims.

Accordingly, in some aspects, a stamping system includes a jig having a plurality of first alignment features spaced about the jig, and a stamping block including a second alignment feature. The second alignment feature is selectively alignable with individual ones of the plurality of first alignment features and is provided to align the stamping block with respect to the jig.

The plurality of first alignment features may include one of recesses and projections, and the second alignment feature may include the other of a recess and a projection. Individual ones of the first alignment features and the second alignment feature may be substantially wedge-shaped. The jig may include an outer portion, and the first alignment features may be disposed on the outer portion. The jig may be substantially ring shaped and may include an inner portion. The plurality of first alignment features may be disposed on both the inner portion and the outer portion of the jig. The jig may also include a pivot member slidingly received by an inner portion of the jig. The first alignment features may include indicia. The jig may include stamp alignment indicia disposed adjacent selected ones of the plurality of first alignment features to aid a user in forming a predetermined stamping pattern. The jig may be one of substantially oval, substantially circular, and substantially rectangular. The stamping block may have at least one additional second alignment feature. The stamping system may also include a plurality of stamps, where each stamp may be removably attachable to the stamping block. The first alignment features may be substantially uniformly spaced about the jig.

In other aspects, a stamping system includes a substantially ring-shaped jig having an inner portion, an outer portion, and a plurality of first alignment features disposed around at least one of the inner and outer portions. The stamping system also includes a stamping block having a second alignment feature. The second alignment feature is selectively engageable with individual ones of the plurality of first alignment features and is provided to align the stamping block with respect to the jig.

The plurality of first alignment features may include one of recesses and projections, and the second alignment feature may include the other of a recess and a projection. Individual ones of the first alignment features and the second alignment feature may be substantially wedge-shaped. The first alignment features may be substantially uniformly spaced around both the inner portion and the outer portion of the jig. The jig may include includes stamp alignment indicia disposed adjacent selected ones of the plurality of first alignment features to aid a user in forming a predetermined stamping pattern. The jig may be one of substantially oval, substantially circular, and substantially rectangular. The stamping block may have at least one additional second alignment feature. The stamping system may also include a plurality of stamps, where each stamp may be removably attachable to the stamping block.

Various features and advantages of the invention will be apparent from the following specification taken in conjunction with the following drawings.

### BRIEF DESCRIPTION OF THE DRAWINGS

FIG. 1 is a perspective view of a stamping system.

FIG. 2 is a top view of a circle ring jig and stamping block of the stamping system of FIG. 1.

FIG. 3 is a top view of a circle jig and stamping block of the stamping system of FIG. 1.

FIG. 4 is a perspective view of the circle jig and stamping block of FIG. 3.

FIG. 5 is a top view of an oval jig similar to the circle jig of FIG. 3 but having an oval shape.

FIG. 6 is a side view of the oval jig of FIG. 5

FIG. 7 is a top view of an oval ring jig similar to the circle ring jig of FIG. 2 but having an oval shape.

FIG. 8 is a side view of the oval ring jig of FIG. 7.

FIG. 9 is a top view of a stamping handle of the stamping block of FIG. 2.

FIG. 10 is a side view of the stamping handle of FIG. 9.

FIG. 11 is an end view of the stamping handle of FIG. 9.

FIG. 12 is a perspective view illustrating two configurations of an interchangeable stamping die of the stamping block of FIG. 3.

FIG. 13 is an end view of one of the stamping dies of FIG. 12.

FIG. 14 is a perspective view of a square ring jig and a stamping block according to an alternate embodiment.

FIG. 15 is a perspective view of a square jig according to an alternate embodiment.

FIG. 16 is a perspective view of an adjustable elongated straight jig according to an alternate embodiment.

FIG. 17 is a perspective view of an adjustable elongated curved jig according to an alternate embodiment.

FIG. 18 illustrates a method of using the straight jig of FIG. 16 to stamp a rounded corner.

FIG. 19 illustrates a method of using the straight jig of FIG. 16 to stamp a circle.

FIG. 20 illustrates a method of using the straight jig of FIG. 16 to stamp a straight line.

FIG. 21 is a top view of a jig pivot guide for use with the stamping jigs of the foregoing Figures.

FIG. 22 is a side view of the jig pivot guide of FIG. 21.

FIG. 23 is a top view showing a first method of using the jig pivot guide of FIG. 21.

FIG. 24 is a top view showing a second method of using the jig pivot guide of FIG. 21.

The components in the drawings are not necessarily to scale.

### DETAILED DESCRIPTION

While the subject matter of this disclosure can be practiced and carried out in many different ways, certain specific embodiments are shown in the drawings and described in detail with the understanding that such drawings and description are exemplary in nature and are not intended to limit the scope of the invention set forth in claims only to those embodiments that are illustrated and described.

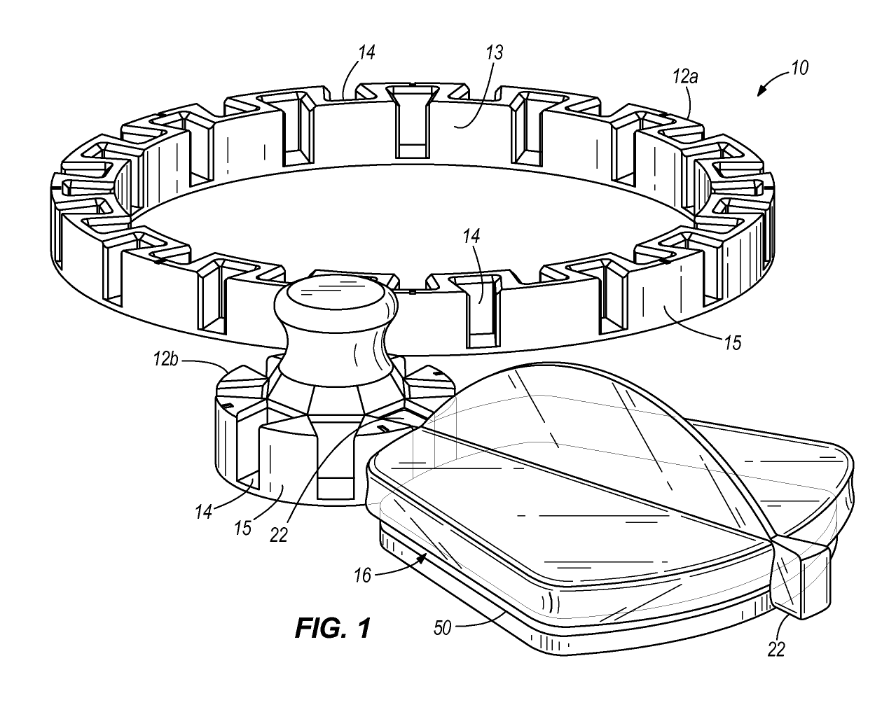

Referring now to the drawings, and initially to FIGS. 1-4, a stamping system 10 is shown for applying stamps to a work surface such as paper or other media. The stamping system 10 is comprised of at least one jig 12a and/or 12b and at least one stamping block 16 configured to be received in or otherwise engaged with the jig 12.

The stamping system of FIGS. 1-4 includes a circle ring jig 12a and a circle jig 12b. Each jig 12a, 12b is generally configured in the form of a predetermined geometric shape that defines a jig perimeter. For example, the circle ring jig 12a includes an inner portion 13 and an outer portion 15, whereas the circle jig 12b includes only an outer portion 15. Each jig 12a, 12b includes a plurality of first alignment features in the form of recesses or key holes 14 disposed about the outer portion 15. The circle ring jig 12a also includes first alignment features, e.g., key holes 14, disposed about the inner portion 13. Each of the key holes 14 is configured to receive a corresponding second alignment feature in the form of one or more projections or keys 22 provided on the stamping block 16. It should be appreciated that the configuration of the jigs 12a, 12b and the stamping block 16 could be reversed such that the jigs 12a, 12b, include a plurality of projections or keys and the stamping block 16 includes one or more recesses or key holes.

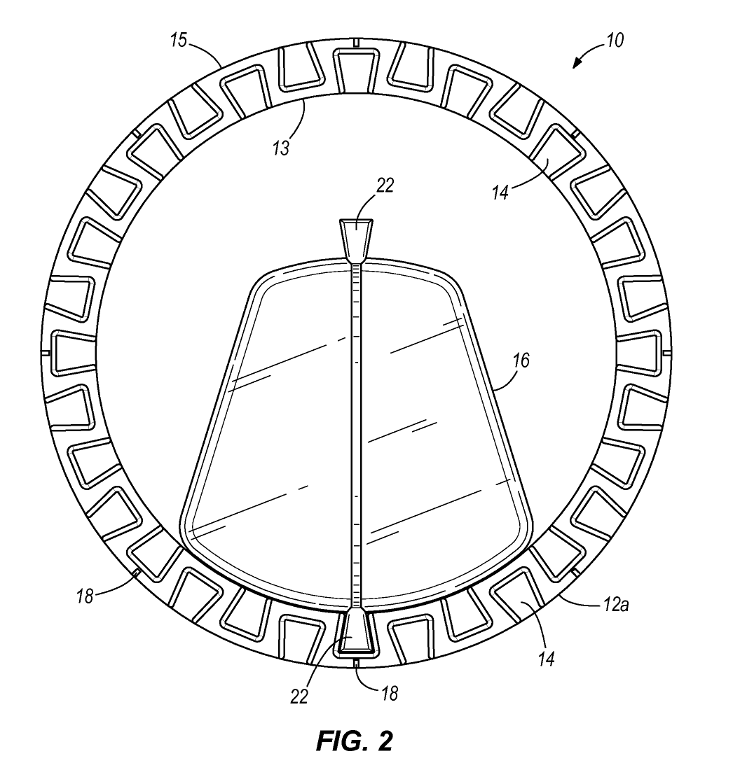

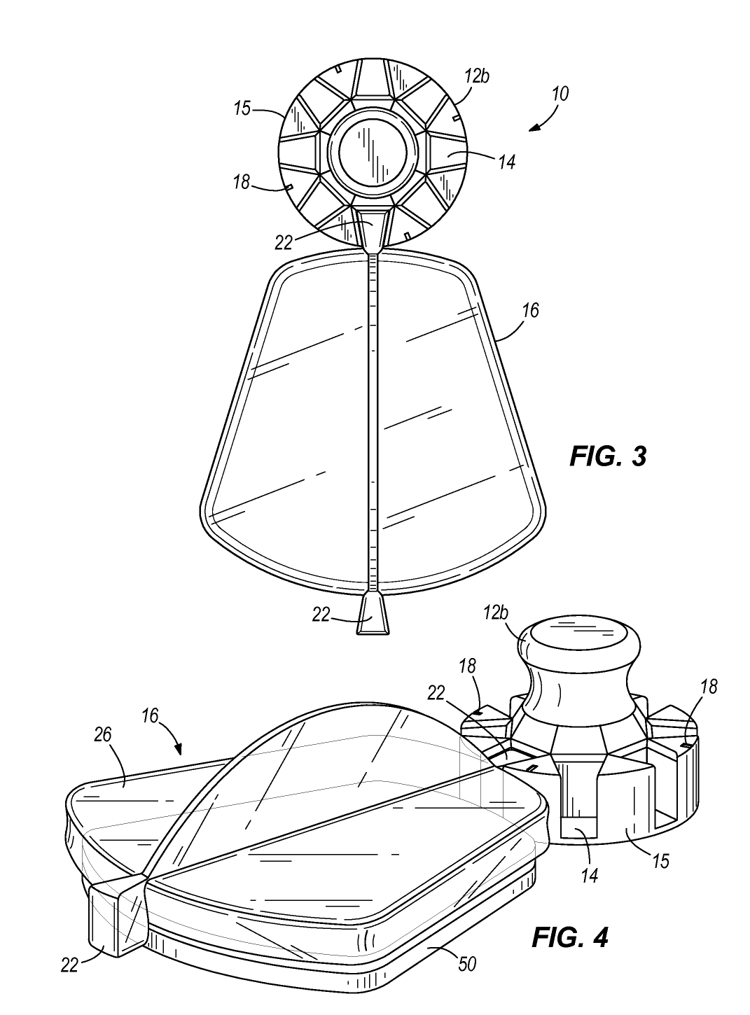

In some embodiments, the jigs 12a, 12b include stamp alignment indicia 18 disposed adjacent certain ones of the key holes 14 to aid in alignment of the stamping block 16 for forming predetermined patterns (see FIGS. 2-3). The stamping block 16 can include similar stamp alignment indicia corresponding to the indicia 18 disposed adjacent the key holes 14 to assist the user in matching the orientation of the stamping block 16 to specific key holes 14 for providing a desired stamp design.

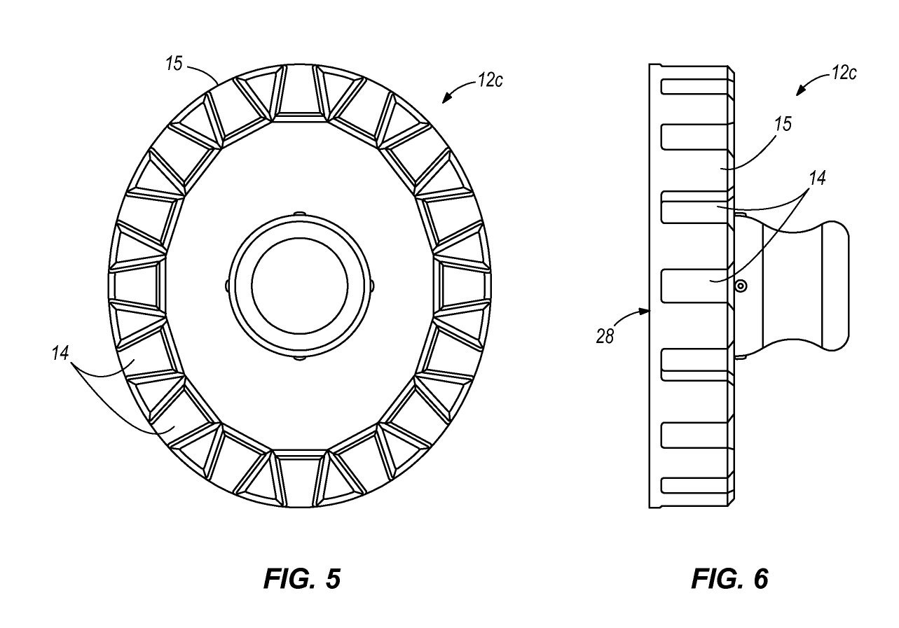

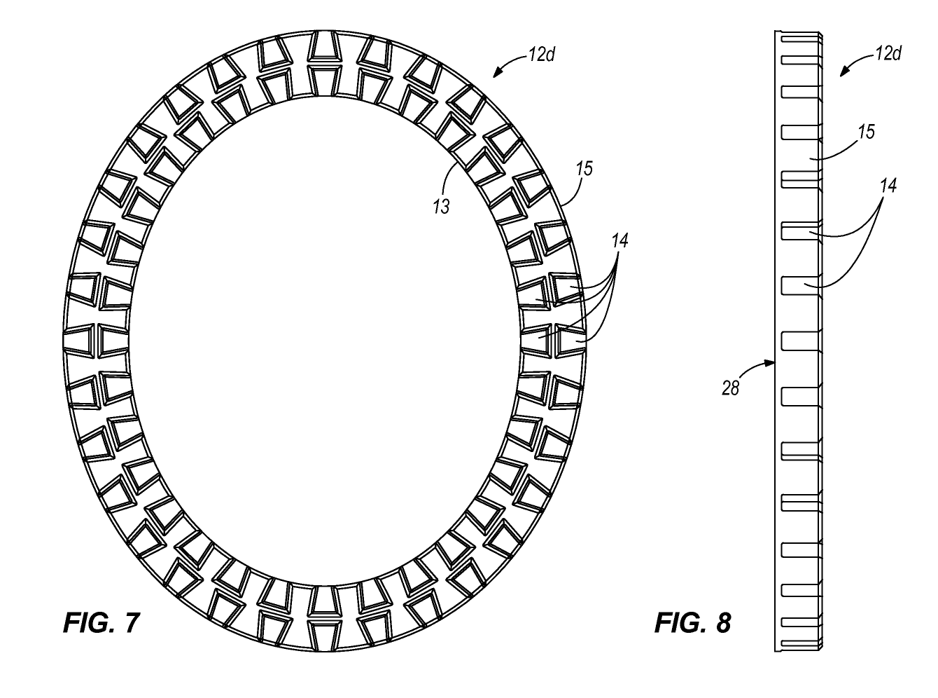

Other embodiments of jigs 12 having other shapes are illustrated in FIGS. 5 through 8. FIGS. 5 and 6 illustrate an oval jig 12c having a generally oval-shaped perimeter and key holes 14 disposed about an outer portion 15 thereof. FIGS. 7 and 8 illustrate an oval ring jig 12d having a generally oval-shaped perimeter and key holes 14 disposed about both an inner portion 13 and an outer portion 15 thereof.

Each jig 12a-12d also has a bottom surface 28 (see FIGS. 6 and 8). According to one embodiment, at least a portion of the bottom surface 28 of the jig 12 can be removably adhered to a work surface so as to resist movement of the system 10 during use of the stamping system 10. Accordingly, it is contemplated that a tacky material can be applied to at least a portion of the bottom surface 28 of the jig 12. Alternatively, the bottom surface 28 of the jig 12 (or portions thereof) may be roughened such that the roughened portions of the bottom surface itself provide a frictional resistive force to assist in preventing the jig 12 from sliding on a work surface.

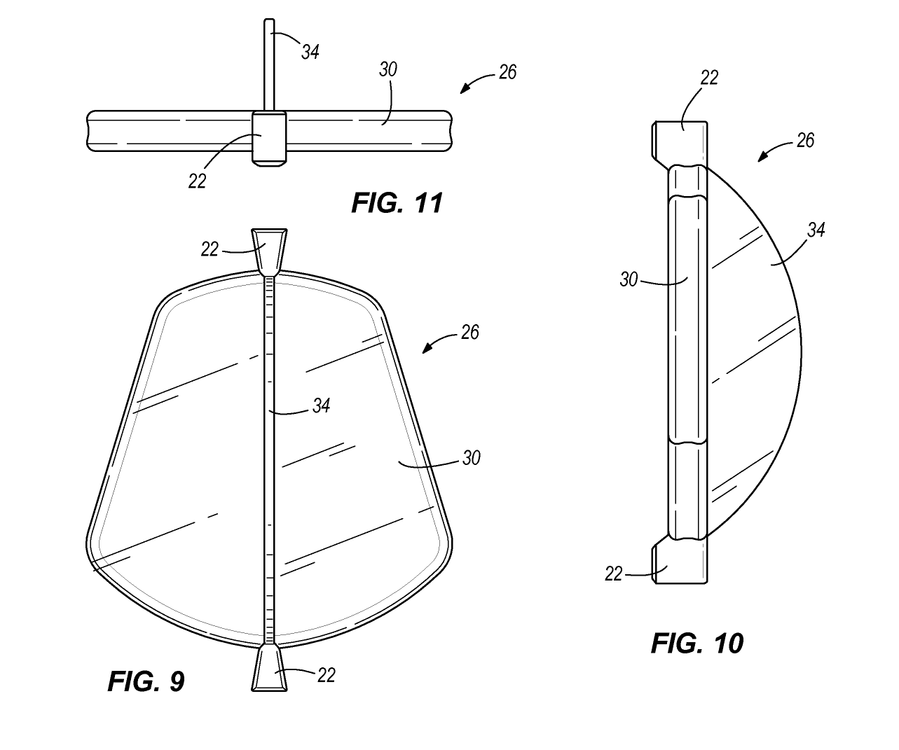

Referring also to FIGS. 9 through 11, the stamping block 16 includes a stamping handle 26 that, in some embodiments, is formed of a clear material to aid in visually aligning the stamping block 16. The stamping handle 26 includes a base 30, from which the keys 22 extend, and a handle portion 34 extending from the base 30. As shown in FIGS. 1 and 4, a stamping die 50 having an image formed therein can be attached, secured, or coupled to the underside of the stamping handle 26. The stamping die 50 can be permanently or removably attached or secured to the stamping handle 26 in a variety of ways, such as by adhesive, friction fits, hook loop connections, a cling layer (as discussed below), and the like, without limitation.

Referring also to FIGS. 10 and 11, one embodiment of an interchangeable stamping die 50 that may be used with the stamping handle 26 includes an ink receiving printing layer 52, a first foam layer 54, and an electrostatic cling film layer 56. The ink receiving printing layer 52 has an image surface 58 and an opposed second surface. The image surface 58 of the ink receiving printing layer 52 is preferably formed from rubber. However, it is contemplated that the image surface 58 can also be formed from wood or any other surface suitable for transferring ink to a work surface. The image surface 58 may include a raised surface image or, alternatively, an engraved or impressed image.

The first foam layer 54 has a first surface and an opposed second surface. In one exemplary embodiment, the first foam layer is attached to the second surface of the ink receiving print surface 52 by a first adhesive layer.

The electrostatic cling film layer 56 includes a first surface and a cling surface 60. The first surface of the electrostatic cling film layer 56 is attached to the first surface of the first foam layer 54 by, for example, a second adhesive layer. The cling surface 60 of the electrostatic cling film layer 56 is adapted to be releasably secured to a stamp mount, such as the stamping handle 26 of FIGS. 9 through 11, without the use of an adhesive layer. It is contemplated that the stamp mount to which the cling surface 60 of the electrostatic cling film layer 56 may be releasably attached can be any surface suitable for functioning as a mounting surface or handle for the interchangeable stamp die 50. In some embodiments, the stamp mount may also be an exposed surface of a second stamp. According to one embodiment, the cling surface 60 of the electrostatic film layer 56 includes indicia 62 disposed thereon corresponding to an image formed in the ink receiving printing layer 52. As shown in FIG. 13, the cling surface 60 is flat and smooth.

According to one embodiment, the interchangeable stamping die 50 may also include a second foam layer, as suggested by the broken line extending through the first foam layer 54 in FIG. 13. The second foam layer can be disposed between the first foam layer and the electrostatic cling film layer. It is contemplated that the first foam layer has a first foam density and the second foam layer has a second foam density. It is further contemplated that the first foam layer can have a first compressibility and the second foam layer can have a second compressibility.

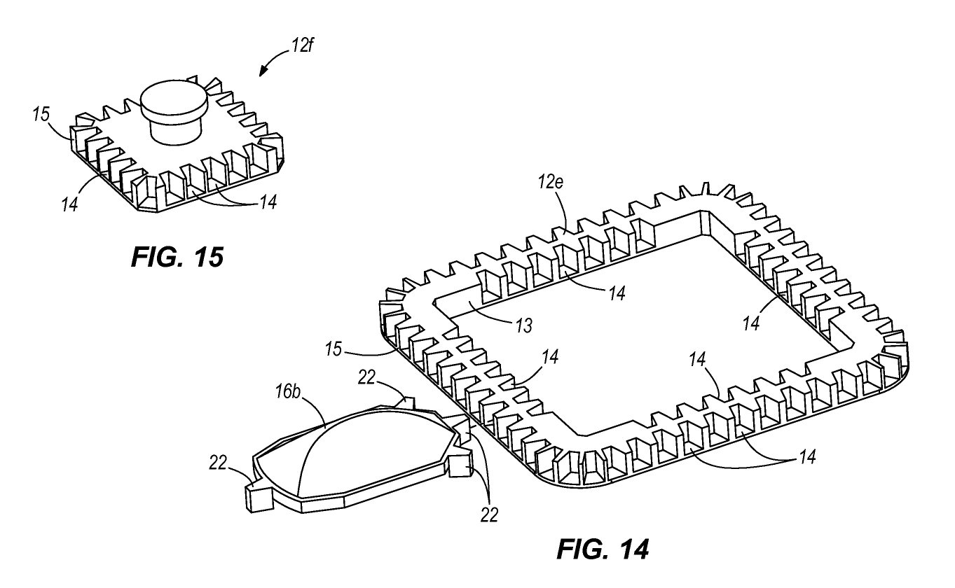

FIG. 14 illustrates yet another alternative stamping jig in the form of a square ring jig 12e and an alternative stamping block 16b. The square ring jig 12e includes first alignment features in the form of key holes 14 on both inner and outer portions 13, 15 that are configured to receive one of a plurality of corresponding second alignment features in the form of keys 22 provided on the stamping block 16b. The stamping block 16b includes a key 22 on each end and also includes two keys located on side portions that are angled at approximately 45 degrees from one of the ends. The additional keys 22 provided on stamping block 16b increase the possible orientations at which the stamping die 50 can be positioned with respect to the stamping jig 12e (or any other stamping jig 12) without having to adjust the position of the stamping die 50 on the stamping handle 26.

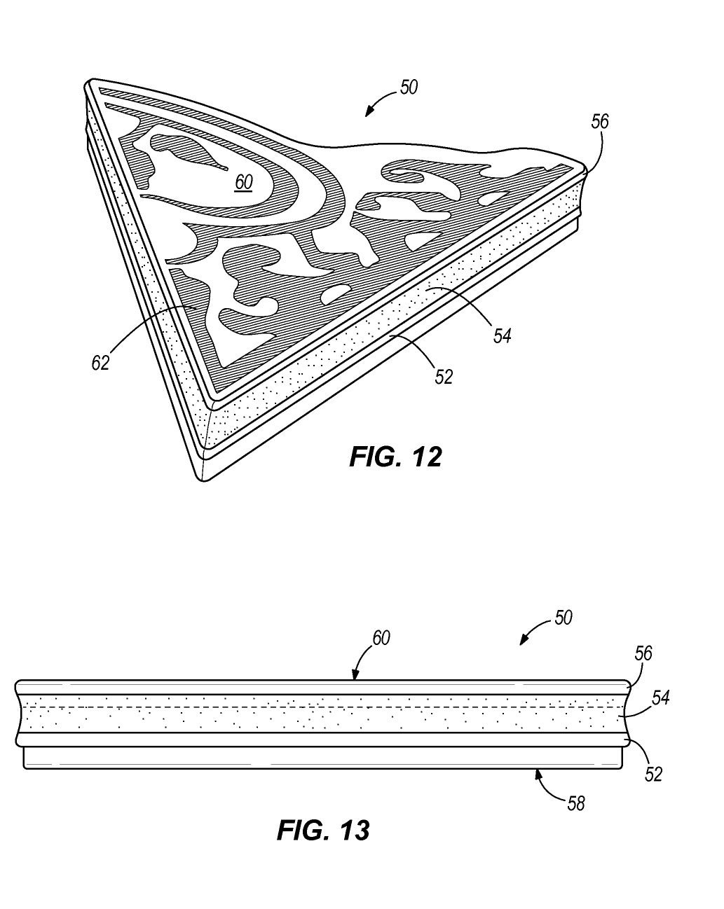

FIG. 15 illustrates yet another alternative stamping jig in the form of a square jig 12f. The square jig 12f includes first alignment features in the form of key holes 14 on its outer portion 15 for receiving one of the keys 22 on the stamping block 16b of FIG. 12.

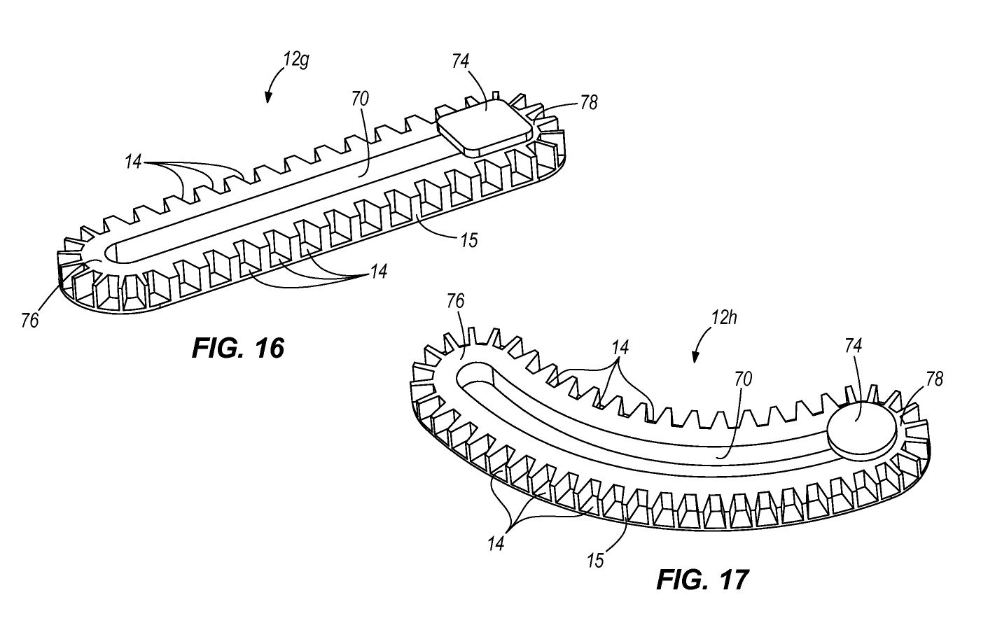

FIG. 16 illustrates an adjustable elongated straight jig 12g having a straight and elongated shape. The straight jig 12g includes first alignment features in the form of key holes 14 on its outer portion 15 for receiving one of the keys 22 on the stamping block 16b of FIG. 14. The straight jig 12g also includes an opening in the form of an elongated slot 70 extending through a central portion of the straight jig 12g substantially from end to end, and a button or pivot member 74 slidingly received within the slot 70. The pivot member 74 may be removably or non-removably received within elongated slot 70. In the illustrated embodiment, one end 76 of the straight jig 12g is rounded and defines a substantially continuous curve, while the other end 78 of the straight jig 12g is squared off and includes sharper corner portions with a substantially straight portion extending therebetween. Other embodiments of the straight jig 12g can include ends 76, 78 that are both curved or both squared off.

FIG. 17 illustrates an adjustable elongated curved jig 12h that is similar to the adjustable straight jig 12g but that has a curved and elongated shape. The curved jig 12h defines a single, substantially constant radius curve; however, other embodiments may be substantially S-shaped or may include portions having curvatures of varying radii. The curved jig 12h includes key holes 14 on its outer portion 15 for receiving one of the keys 22 on the stamping block 16b of FIG. 14. The curved jig 12h includes a curved and elongated slot 70 extending through a central portion of the curved jig 12h substantially from end to end, and a button or pivot member 74 slidingly received within the slot 70. The pivot member 74 may be removably or non-removably received within elongated slot 70. In the illustrated embodiment, ends 76, 78 of the curved jig 12h are each curved and smoothly rounded. In other embodiments, one or both of the ends 76, 78 may be squared off in a manner to what is illustrated and described with respect to the end 78 of the straight jig 12g.

In both the adjustable straight jig 12g of FIG. 16 and the adjustable curved jig 12h of FIG. 17, the pivot member 74 functions to expand the possible patterns of stamping that can be performed with the jigs 12g, 12h. In operation, a user can press the pivot member 74 against the work surface such that the pivot member 74 remains substantially fixed with respect to the work surface. The user can then rotate or pivot the jig 12h or 12g around the pivot member 74, or can slide the jig 12h or 12g along pivot member 74 by way of the slot 70.

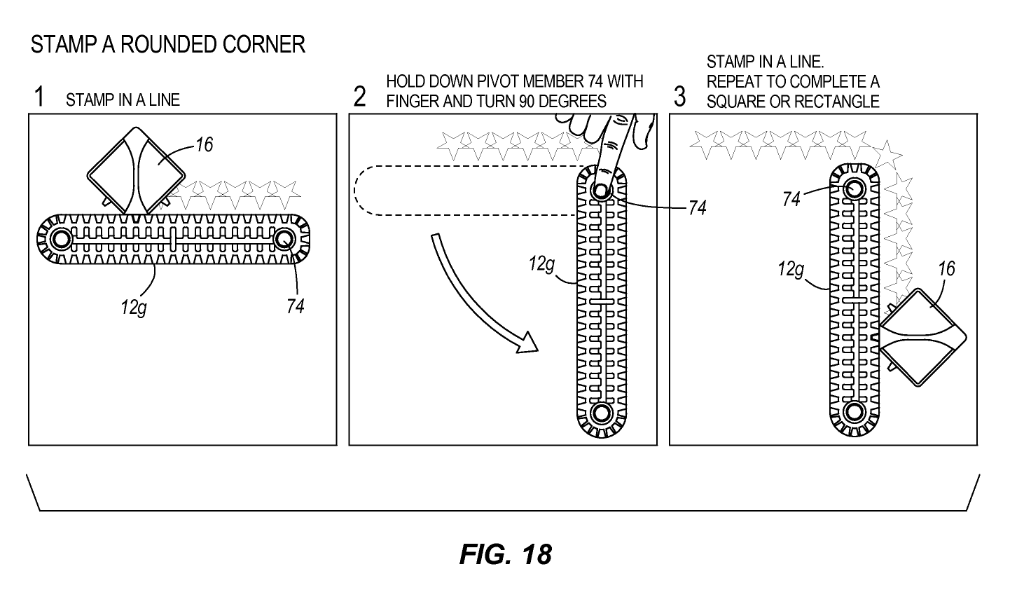

FIG. 18 illustrates one exemplary method of using the straight jig 12g for stamping a rounded corner. With the jig 12g held substantially fixed against the work surface, the user stamps in a substantially straight line by moving the stamping block 16 along the key holes 14 on the outer portion 14 of the straight jig 12g. When the user reaches the end 78 of the straight jig 12g, the user presses the pivot member 74 against the work surface and pivots the straight jig 12g about the pivot member 74. In the illustrated embodiment, the user has pivoted the straight jig 12g approximately 90 degrees; however, it should be appreciated that the user can pivot the jig 12g through any angle of choice to obtain a desired stamping pattern. The user also stamps around the appropriate key holes 14 that define the curve of the end 78. This step can be performed before or after the user has pivoted the jig 12g about the pivot member 74. Once the user has stamped around the corner, the user can continue to stamp in a straight line along the outer portion 14 of the straight jig 12g. The user can continue in this manner to form a square, rectangle, or substantially any other shape having a plurality of straight sides joined by angles.

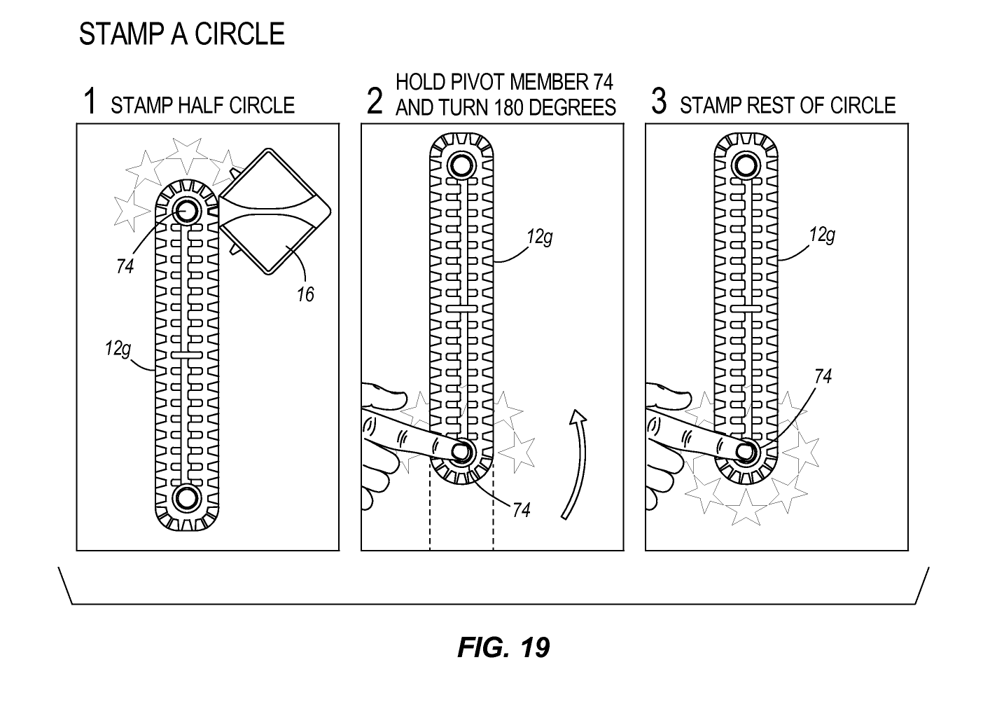

FIG. 19 illustrates one exemplary method of using the straight jig 12g for stamping a relatively small circle. With the jig 12g held substantially fixed against the work surface, the user begins stamping by inserting the stamping block 16 into one of the key holes 14 that is directly adjacent the rounded end 76 and oriented substantially perpendicular to the long axis of the jig 12g. The user then stamps around the rounded end 76 to form a half circle. The user then presses the pivot member 74 against the work surface and pivots the straight jig 12g approximately 180 degrees about the pivot member 74. The user then continues stamping around the rounded end 76 to complete the circle. Note that, although it involves additional steps, by using the straight jig 12g to stamp the circle discussed above, a user may not necessarily require the circle jig 12b shown in FIG. 4.

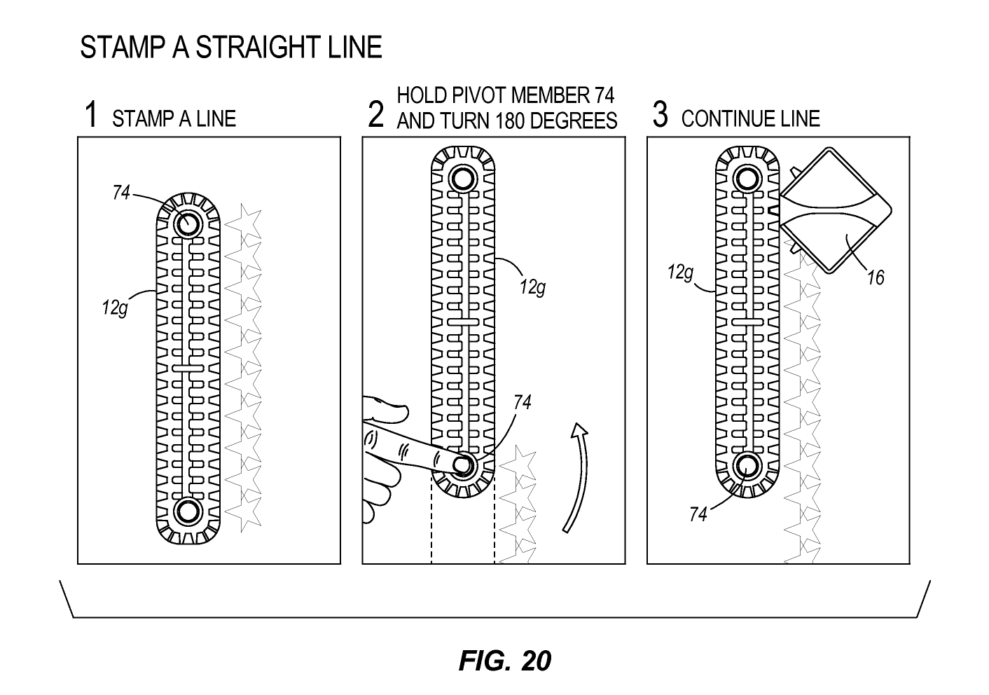

FIG. 20 illustrates one exemplary method of using the straight jig 12g for stamping a continuous straight line. With the straight jig 12g held substantially fixed against the work surface, the user stamps in a substantially straight line by moving the stamping block 16 along the key holes 14 on the outer portion 14 of the straight jig 12g. When the user reaches the end 78 of the straight jig 12g, the user presses the pivot member 74 against the work surface and pivots the jig 12g about the pivot member 74 through approximately 180 degrees. When the straight jig 12g is aligned with the previously completed row of stamps, the user can continue stamping in a straight line, and can repeat the process until a line of stamps of the desired length is obtained. In some embodiments, such as the embodiment of the straight jig 12g shown in FIG. 16, which includes a substantially continuous slot 70, instead of pivoting the jig 12g about the pivot member 74, the jig 12g can instead be slid along the work surface by way of the slot 70 while the pivot member 74 is held stationary.

The exemplary methods of FIGS. 18-20 can also be used in the alternative or in combination with the curved jig 12h of FIG. 17 to form curved patterns, such as S-shaped patterns, extended arch patterns of substantially constant radius, patterns having combinations of straight and curved sections, and the like.

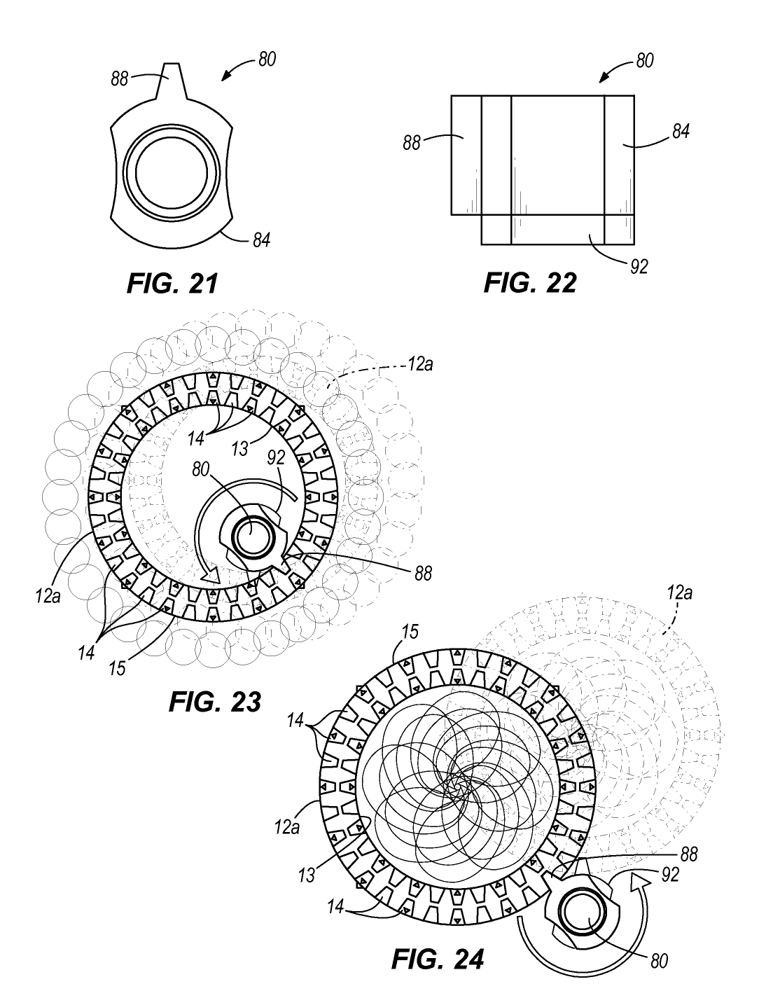

Turning now to FIGS. 21 and 22, a jig pivot guide 80 includes an upper, rotatable portion 84 including a third alignment feature in the form of a tooth or key 88 that, like the second alignment feature in the form of a key 22 provided on the stamping block 16, is configured to fit within the first alignment features or key holes 14 of the various jigs 12 described above. The pivot guide 80 also includes a base 92 (FIG. 22) rotatably coupled to the rotatable portion 84 and configured for engagement with the work surface.

As shown in FIGS. 23 and 24, the jig pivot guide 80 can be used to pivot a jig 12 about a substantially fixed point on the work surface to obtain desired stamping patterns. For example, FIG. 23 illustrates the key 88 of the jig pivot guide 80 engaged with one of the key holes 14 on the inner portion 13 of the circle ring jig 12a. In FIG. 23, the circle ring jig 12a was originally positioned as shown by the lighter weight lines and a stamping block 16 was used to stamp a complete circle around the outer portion 15 of the circle ring jig 12a. The pivot guide 80 was then used to pivot the circle ring jig 12a about a substantially fixed point on the work surface so that another circle of stamps could be created at a location slightly offset from first circle of stamps, as shown in heavy lines in FIG. 21. More specifically, with the key 88 of the jig pivot guide 80 engaged with one of the key holes 14 on the inner portion 13 of the circular ring jig 12a, and without substantial movement of the base 92 of the pivot guide 80, the rotatable portion 84 and the circular ring jig 12a can be rotated with respect to the base 92 to alter the location of the circle ring jig 12a. Because the base 92 remains stationary on the work surface, and because the key of the pivot guide 80 remains engaged with one of the key holes 22 on the circle ring jig 12a, relatively precise reorientation of the circle ring jig 12a about a substantially fixed location on the work surface can be obtained.

FIG. 24 shows a method of using the jig pivot guide 80 similar to FIG. 23, but where the stamping operation is carried out using the key holes 14 on the inner portion 13 of the circular ring jig 12a, and the key 88 of the jig pivot guide 80 is engaged with a key hole 22 on the outer portion 15 of the circular ring jig 12a. The stamping and reorientation of the circular ring jig 12a shown in FIG. 24 is otherwise similar to that shown in and described with respect to FIG. 21.

While specific embodiments have been illustrated and described, numerous modifications come to mind without significantly departing from the spirit of the disclosure, and the scope of protection is to be limited only by the scope of the accompanying claims.

What is claimed is:

1. A stamping system comprising:
a jig having a plurality of first alignment features spaced about the jig; and
a stamping block including a second alignment feature, the second alignment feature selectively alignable with individual ones of the plurality of first alignment features and being provided to align the stamping block with respect to the jig.

2. The stamping system of claim 1, wherein the plurality of first alignment features includes one of recesses and projections, and wherein the second alignment feature includes the other of a recess and a projection and is engageable with individual ones of the plurality of first alignment features.

3. The stamping system of claim 1, wherein individual ones of the first alignment features and the second alignment feature are substantially wedge-shaped.

4. The stamping system of claim 1, wherein the jig includes an outer portion, and the first alignment features are disposed on the outer portion.

5. The stamping system of claim 4, wherein the jig is substantially ring shaped and includes an inner portion, and wherein the plurality of first alignment features is disposed on both the inner portion and the outer portion of the jig.

6. The stamping system of claim 1, wherein the jig further comprises a pivot member slidingly received by an inner portion of the jig.

7. The stamping system of claim 1, wherein the first alignment features include indicia.

8. The stamping system of claim 1, wherein the jig includes stamp alignment indicia disposed adjacent selected ones of the plurality of first alignment features to aid a user in forming a predetermined stamping pattern.

9. The stamping system of claim 1, wherein the jig is one of substantially oval, substantially circular, and substantially rectangular.

10. The stamping system of claim 1, wherein the stamping block has at least one additional second alignment feature.

11. The stamping system of claim 1, further comprising a plurality of stamps, each stamp removably attachable to the stamping block.

12. The stamping system of claim 1, wherein the first alignment features are substantially uniformly spaced about the jig.

13. A stamping system comprising:
a substantially ring-shaped jig having an inner portion, an outer portion, and a plurality of first alignment features disposed around at least one of the inner and outer portions; and
a stamping block including a second alignment feature, the second alignment feature being selectively engageable with individual ones of the plurality of first alignment features and being provided to align the stamping block with respect to the jig.

14. The stamping system of claim 13, wherein the plurality of first alignment features includes one of recesses and projections, and wherein the second alignment feature includes the other of a recess and a projection.

15. The stamping system of claim 13, wherein individual ones of the first alignment features and the second alignment feature are substantially wedge-shaped.

16. The stamping system of claim 13, wherein the first alignment features are substantially uniformly spaced around both the inner portion and the outer portion of the jig.

17. The stamping system of claim 13, wherein the jig includes stamp alignment indicia disposed adjacent selected ones of the plurality of first alignment features to aid a user in forming a predetermined stamping pattern.

18. The stamping system of claim 13, wherein the jig is one of substantially oval, substantially circular, and substantially rectangular.

19. The stamping system of claim 13, wherein the stamping block has at least one additional second alignment feature.

20. The stamping system of claim 13, further comprising a plurality of stamps, each stamp removably attachable to the stamping block.
